(19) United States
(12) Patent Application Publication
(10) Pub. No.: US 2026/0073907 A1
(43) Pub. Date: Mar. 12, 2026

(54) Streaming Automatic Speech Recognition Via Differentially Private Fusion of Data From Multiple Sources

(71) Applicant: Google LLC, Mountain View, CA (US)

(72) Inventors: Virat Vishnu Shejwalkar, Amherst, MA (US); Om Dipakbhai Thakkar, Sunnyvale, CA (US); Arun Narayanan, Milpitas, CA (US); Steve Chien, Mountain View, CA (US); Nicole Rafidi, Mountain View, CA (US)

(73) Assignee: Google LLC, Mountain View, CA (US)

(21) Appl. No.: 19/326,528

(22) Filed: Sep. 11, 2025

Related U.S. Application Data
(60) Provisional application No. 63/694,172, filed on Sep. 12, 2024.

(51) Int. Cl. G10L 15/06; G10L 15/065; G10L 15/16

(52) U.S. Cl. CPC G10L 15/063; G10L 15/065; G10L 15/16; G10L 2015/0635

(57) ABSTRACT

A method includes obtaining a plurality of sets of private training utterances. Each corresponding set of private training utterances is obtained from a different source and associated with a speech domain that is different than the speech domains associated with the other sets of private training utterances. The method also includes training a speech recognition model by obtaining a current version of the speech recognition model, selecting a batch of private training utterances from one of the plurality of sets of private training utterances, determining a differentially private gradient for updating the current version of the speech recognition model based on the selected batch of private training utterances, and updating the current version of the speech recognition model using the differentially private gradient. The method also includes adapting the trained speech recognition model to learn how to recognize speech in a target speech domain.

### CROSS REFERENCE TO RELATED APPLICATIONS

This U.S. Patent Application claims priority under 35 U.S.C. § 119(e) to U.S. Provisional Application 63/694,172, filed on Sep. 16, 2024. The disclosure of this prior application is considered part of the disclosure of this application and is hereby incorporated by reference in its entirety.

### TECHNICAL FIELD

This disclosure relates to streaming automatic speech recognition via differentially private fusion of data from multiple sources.

### BACKGROUND

Automatic speech recognition (ASR), the process of taking an audio input and transcribing it into text, has greatly been an important technology that is used in mobile devices and other devices. In general, ASR attempts to provide accurate transcriptions of what a person has said by taking an audio input (e.g., speech utterance) and transcribing the audio input into text. Modern ASR models continue to improve in both accuracy (e.g., a low word error rate (WER) and latency (e.g., delay between the client speaking and the transcription) based on the ongoing development of deep neural networks.

Machine learning models, such as those used for automatic speech recognition (ASR), are frequently trained on large datasets to achieve a desired level of performance across various data distributions, sometimes referred to as data domains. In some conventional training approaches, a multi-source training technique is employed where data from all target domains is collected and combined into a single, comprehensive dataset. A machine learning model is then trained using this combined dataset. This approach allows the model to learn from the diverse characteristics present across all data sources. While effective, combining data from multiple sources is not always feasible. For instance, data from different sources may be subject to privacy constraints or organizational policies that prohibit it from being co-mingled with data from other sources.

Domain adaptation provides a training technique when data from different source is subject to privacy constraints that prohibit it from being co-mingled from other sources during training. In a typical domain adaptation workflow, a public-base model is first trained on a general, publicly available dataset that has no privacy restrictions. Following this initial training, the public-base model is then adapted to specific target domains. This adaptation phase involves training a set of per-domain parameters using only the data from that particular domain. As a result, separate adapted models are generated for each domain, without ever combining the private data from the different sources. However, domain adaptation methods can produce models that do not perform as well as those trained using a multi-source training recipe. This performance gap can arise because the public-base model, trained on general data, may not be well-aligned with the specific data distributions of the various target domains. Because each adaptation is performed in isolation using only one domain's data, the process does not leverage the diverse data available across all of the other private sources. Consequently, there remains a need to address the limitations of existing domain adaptation techniques where combining private, multi-source data is not viable.

### SUMMARY

One aspect of the disclosure provides a computer-implemented method that when executed on data processing hardware causes the data processing hardware to perform operations that include obtaining a plurality of sets of private training utterances. Each each corresponding set of private training utterances is obtained from a corresponding different source and associated with a corresponding speech domain that is different than the speech domains associated with the other sets of private training utterances. At each respective training step of a plurality of training steps subsequent to an initial training step, the operations also include training a speech recognition model by: obtaining a current version of the speech recognition model updated during the training step that immediately precedes the respective training step; selecting a batch of private training utterances from one of the plurality of sets of private training utterances; determining a differentially private gradient for updating the current version of the speech recognition model based on the selected batch of private training utterances; and updating the current version of the speech recognition model using the differentially private gradient; and adapting the trained speech recognition model to learn how to recognize speech in a target speech domain from the plurality of speech domains using the corresponding set of private training utterances associated with the target speech domain.

Implementations of the disclosure may include one or more of the following optional features. In some implementations, the speech recognition model is initially pretrained on public training data associated with multiple speech domains. In some examples, selecting the batch of private training utterances from the one of the plurality of sets of private training utterances includes randomly selecting the one of the plurality of sets of private training utterances from the plurality of sets of private training utterances, and selecting a subset of the private training utterances from the randomly selected set of private training utterances.

Determining the differentially private gradient for updating the current version of the speech recognition model based on the selected batch of private training utterances includes determining a per-utterance differentially private gradient for each private training utterance in the batch of private training utterances selected from the one of the plurality of sets of private training utterances, clipping each respective per-utterance differentially private gradient to have a maximum loss, aggregating the clipped per-utterance differentially private gradients, and adding noise to the aggregated clipped per-utterance differentially private gradients.

In some implementations, the speech recognition model includes an encoder comprising a plurality of multi-head attention layers, and a decoder having a recurrent neural network-transducer (RNN-T) architecture. Adapting the trained speech recognition model may include using modular domain adaptation by at least one of fine-tuning a corresponding subset of parameters of the encoder based on the corresponding set of private training utterances associated with the target speech domain while the remaining parameters of the encoder and parameters of the decoder are held fixed, or fine-tuning weights of adaptor modules specific to the target speech domain based on the corresponding set of private training utterances associated with the target speech domain while the parameters of the encoder and the decoder are held fixed. Here, each corresponding adaptor module of the adaptor modules specific to the target speech domain may be inserted in parallel between a corresponding pair of consecutive multi-head attention layers of the encoder.

In some examples, the target speech domain includes speech in a target native language and adapting the trained speech recognition model includes adapting the trained speech recognition model using language-dependent adapter modules by fine-tuning a corresponding set of language-dependent weights associated with each language dependent adapter module that are specific to the target native language based on the corresponding set of private training utterances associated with the target speech domain while parameters of the encoder and the decoder are held fixed. In these examples, each corresponding language-dependent adapter module may be inserted between a corresponding pair of consecutive multi-head attention layers of the encoder. In some implementations, the plurality of speech domains includes a first speech domain associated with long queries greater than or equal to a first duration, a second domain associated with medium queries less than the first duration and greater than or equal to a second duration, and a third domain associated with short queries less than the second duration.

Another aspect of the disclosure provides a system including data processing hardware and memory hardware in communication with the data processing hardware and storing instructions that when executed on the data processing hardware causes the data processing hardware to perform operations that include obtaining a plurality of sets of private training utterances. Each each corresponding set of private training utterances is obtained from a corresponding different source and associated with a corresponding speech domain that is different than the speech domains associated with the other sets of private training utterances. At each respective training step of a plurality of training steps subsequent to an initial training step, the operations also include training a speech recognition model by: obtaining a current version of the speech recognition model updated during the training step that immediately precedes the respective training step; selecting a batch of private training utterances from one of the plurality of sets of private training utterances; determining a differentially private gradient for updating the current version of the speech recognition model based on the selected batch of private training utterances; and updating the current version of the speech recognition model using the differentially private gradient; and adapting the trained speech recognition model to learn how to recognize speech in a target speech domain from the plurality of speech domains using the corresponding set of private training utterances associated with the target speech domain.

Implementations of the disclosure may include one or more of the following optional features. In some implementations, the speech recognition model is initially pretrained on public training data associated with multiple speech domains. In some examples, selecting the batch of private training utterances from the one of the plurality of sets of private training utterances includes randomly selecting the one of the plurality of sets of private training utterances from the plurality of sets of private training utterances, and selecting a subset of the private training utterances from the randomly selected set of private training utterances.

Determining the differentially private gradient for updating the current version of the speech recognition model based on the selected batch of private training utterances includes determining a per-utterance differentially private gradient for each private training utterance in the batch of private training utterances selected from the one of the plurality of sets of private training utterances, clipping each respective per-utterance differentially private gradient to have a maximum loss, aggregating the clipped per-utterance differentially private gradients, and adding noise to the aggregated clipped per-utterance differentially private gradients.

In some implementations, the speech recognition model includes an encoder comprising a plurality of multi-head attention layers, and a decoder having a recurrent neural network-transducer (RNN-T) architecture. Adapting the trained speech recognition model may include using modular domain adaptation by at least one of fine-tuning a corresponding subset of parameters of the encoder based on the corresponding set of private training utterances associated with the target speech domain while the remaining parameters of the encoder and parameters of the decoder are held fixed, or fine-tuning weights of adaptor modules specific to the target speech domain based on the corresponding set of private training utterances associated with the target speech domain while the parameters of the encoder and the decoder are held fixed. Here, each corresponding adaptor module of the adaptor modules specific to the target speech domain may be inserted in parallel between a corresponding pair of consecutive multi-head attention layers of the encoder.

In some examples, the target speech domain includes speech in a target native language and adapting the trained speech recognition model includes adapting the trained speech recognition model using language-dependent adapter modules by fine-tuning a corresponding set of language-dependent weights associated with each language dependent adapter module that are specific to the target native language based on the corresponding set of private training utterances associated with the target speech domain while parameters of the encoder and the decoder are held fixed. In these examples, each corresponding language-dependent adapter module may be inserted between a corresponding pair of consecutive multi-head attention layers of the encoder. In some implementations, the plurality of speech domains includes a first speech domain associated with long queries greater than or equal to a first duration, a second domain associated with medium queries less than the first duration and greater than or equal to a second duration, and a third domain associated with short queries less than the second duration.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example ASR model.

FIG. 3A is a schematic view of a plurality of adaptor modules inserted between consecutive pairs of multi-head attention layers of the encoder of the ASR model of FIG. 2.

FIG. 3B is a schematic view of a plurality of language-dependent adapter (LDA) module inserted between consecutive multi-head attention layers of the encoder of the ASR model of FIG. 2.

FIGS. 4A-4C are schematic views of a three-stage training process for adapting a base ASR model to a target speech domain using private data from multiple different sources while preserving privacy between those sources.

FIG. 5 is a flowchart of example arrangement of operations for a computer-implemented method of adapting a base ASR model to a target speech domain using private data from multiple different sources while preserving privacy between those sources

FIG. 6 is a schematic view of an example computing device that may be used to implement the systems and methods described herein.

Like reference symbols in the various drawings indicate like elements.

### DETAILED DESCRIPTION

End-to-end (E2E) automatic speech recognition (ASR) models are traditionally structured to operate in either a streaming mode or a non-streaming mode. Conventionally, an E2E ASR includes an encoder and a decoder as the main components. Applications that involve end-user interaction, like voice-search or on-device dictation, may require the model to perform recognition in a streaming fashion. Here, performing recognition in a streaming fashion refers to the ASR model outputting each word or word-piece of an utterance as they are spoken with as little latency as possible. Other applications, like offline video captioning, do not require the model to be streaming and can make use of future context to improve performance.

Machine learning models, such as those used for automatic speech recognition (ASR), are frequently trained on large datasets to achieve a desired level of performance across various data distributions, sometimes referred to as data domains. In some conventional training approaches, a multi-source training technique is employed where data from all target domains is collected and combined into a single, comprehensive dataset. A machine learning model is then trained using this combined dataset. This approach allows the model to learn from the diverse characteristics present across all data sources. While effective, combining data from multiple sources is not always feasible. For instance, data from different sources may be subject to privacy constraints or organizational policies that prohibit it from being co-mingled with data from other sources.

Domain adaptation provides a training technique when data from different source is subject to privacy constraints that prohibit it from being co-mingled from other sources during training. In a typical domain adaptation workflow, a public-base model is first trained on a general, publicly available dataset that has no privacy restrictions (e.g., first phase of domain adaptation). Following this initial training, the public-base model is then adapted to specific target domains (e.g., second phase of domain adaptation). This adaptation phase involves training a set of per-domain parameters using only the data from that particular domain. As a result, separate adapted models are generated for each domain, without ever combining the private data from the different sources. However, domain adaptation methods can produce models that do not perform as well as those trained using a multi-source training recipe. This performance gap can arise because the public-base model, trained on general data, may not be well-aligned with the specific data distributions of the various target domains. Because each adaptation is performed in isolation using only one domain's data, the process does not leverage the diverse data available across all of the other private sources. Consequently, there remains a need to address the limitations of existing domain adaptation techniques where combining private, multi-source data is not viable.

Accordingly, implementation herein are directed toward training ASR modules using private data from multiple different sources while preserving privacy between those sources. As will become apparent, techniques disclosed herein leverage differential privacy (DP) to enable collaborative training without exposing sensitive user data to thereby address increased privacy constrains in machine learning. The techniques disclosed herein insert a DP-based collaborative training phase between the first phase of domain adaptation, where a base ASR model is pre-trained on public and/or non-sensitive training data, and the second phase of domain adaptation, wherein the pre-trained base ASR model is adapted to specific target domains by training a set of per-domain parameters using only the data from that particular domain without ever combining the private data from the different sources. The DP-based collaborative training phase includes using differentially private-stochastic gradient descent (DP-SGD) to fine-tune the pre-trained base ASR model on batches sampled from a respective subset of training utterances associated with a corresponding speech domain. The DP-based collaborative training phase ensures that updates to the ASR model based on the batches sampled from each respective subset of training utterances do not leak information about the training utterances. Thereafter, the now privacy-preserving base model may be adapted to each target speech domain using domain-specific data.

Implementations for enabling privacy-preserving fusion of multi-source data for streaming ASR models includes obtaining a plurality of sets of private training utterances. Here, each corresponding set of private training utterances is obtained from a corresponding different source and is associated with a corresponding speech domain that is different than the speech domains associated with the other sets of private training utterances. At each respective training step of a plurality of training steps subsequent to an initial training step, the DP-based collaborative training phase trains a ASR model by obtaining a current version of the ASR model updated during a previous training step that immediately precedes the respective training step, selecting a batch of private training utterances from one of the plurality of sets of private training utterances, determining a differentially private gradient for updating the current version of the speech recognition model based on the selected batch of private training utterances, and updating the current version of the speech recognition model using the differentially private gradient. Thereafter, the second phase of domain adaptation may be performed on the trained ASR model to adapt the ASR model to learn how to recognize speech in a particular speech domain using the one or more private training utterances associated with the target speech domain. Notably, the application of the differentially private gradient at each respective training step ensures that the probability extracting sensitive information about any subset of the training utterances used for training the ASR model is strictly bounded.

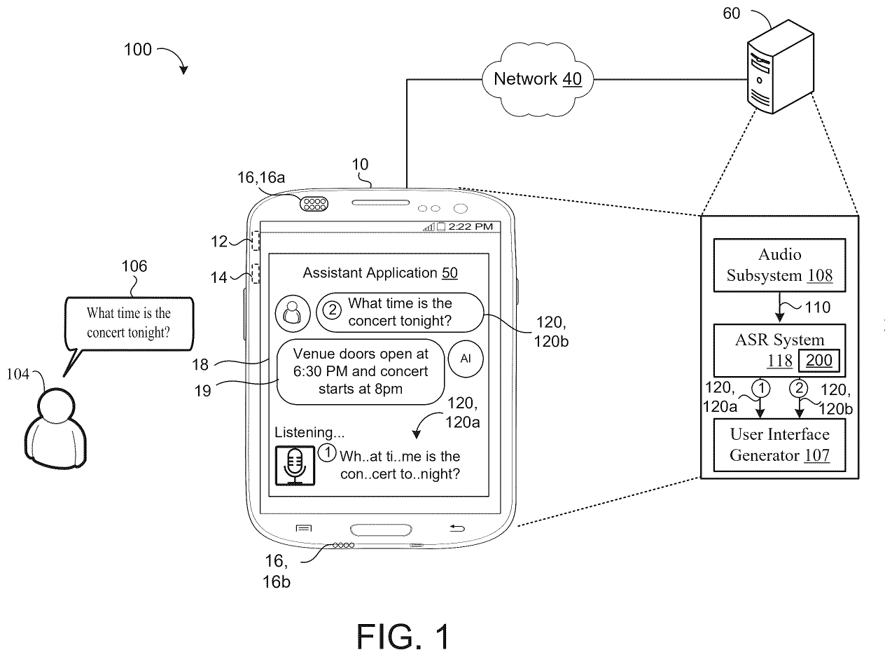

FIG. 1 is an example of a speech system 100. In the speech system 100, a user's 104 manner of interactive with a computing device, such as a user device 10, may be through voice input. The user device 10 (also referred to as a device 10) is configured to capture sounds (e.g., streaming audio data) from one or more users 104 within the speech system 100. Here, the streaming audio data may refer to a spoken utterance 106 by the user 104 that functions as an audible query, a command for the user device 10, or an audible communication captured by the user device 10. Speech-enabled systems of the user device 10 may field the query or the command by answering the query and/or causing the command to be performed/fulfilled by one or more downstream applications.

The user device 10 may correspond to any computing device associated with a user 104 and capable of receiving audio data. Some examples of user devices 10 include, but are not limited to, mobile devices (e.g., mobile phones, tablets, laptops, etc.), computers, wearable devices (e.g., smart watches), smart appliances, internet of things (IoT) devices, vehicle infotainment systems, smart displays, smart speakers, etc. The user device 10 includes data processing hardware 12 and memory hardware 14 in communication with the data processing hardware 12 and stores instructions, that when executed by the data processing hardware 12, causes the data processing hardware 12 to perform one or more operations. The user device 10 further includes an audio system 16 with an audio capture device (e.g., microphone) 16, 16a for capturing and converting spoken utterances 106 within the speech system 100 into electrical signals and a speech output device (e.g., a speaker) 16, 16b for communicating an audible audio signal (e.g., as output audio data from the user device 10). While the user device 10 implements a single audio capture device 16a in the example shown, the user device 10 may implement an array of audio capture devices 16a without departing from the scope of the present disclosure, whereby one or more capture devices 16a in the array may not physically reside on the user device 10, but be in communication with the audio system 16.

In the speech system 100, an automated speech recognition (ASR) system 118 implements an streaming and non-streaming multilingual ASR model 200 and resides on the user device 10 of the user 104 and/or on a remote computing device 60 (e.g., one or more remote servers of a distributed system executing in a cloud-computing environment) in communication with the user device 10 via a network 40. As will become apparent, the ASR model 200 may recognize speech in multiple different languages and operate in the streaming and non-streaming mode. In some examples, the ASR model 200 may be a recurrent neural network-transducer (RNN-T) model. The user device 10 and/or the remote computing device 60 also includes an audio subsystem 108 configured to receive the utterance 106 spoken by the user 104 and captured by the audio capture device 16a, and convert the utterance 106 into a corresponding digital format associated with input acoustic frames 110 capable of being processed by the ASR system 118. In the example shown, the user speaks a respective utterance 106 and the audio subsystem 108 converts the utterance 106 into corresponding audio data (e.g., sequence of acoustic frames) 110 for input to the ASR system 118. Thereafter, the ASR model 200 receives, as input, the sequence of acoustic frames 110 corresponding to the utterance 106, and generates/predicts, at each output step, a corresponding transcription 120 (e.g., speech recognition result/hypothesis) of the utterance 106 as the ASR model receives (e.g., processes) each acoustic frame 110 in the sequence of acoustic frames 110.

In the example shown, the ASR model 200 may perform streaming speech recognition to produce a first pass speech recognition hypothesis (e.g., initial speech recognition result) 120, 120a and generate a second pass speech recognition hypothesis (e.g., a final speech recognition result) 120, 120b by improving the first pass speech recognition hypothesis 120a. The first and second pass speech recognition hypotheses 120a, 120b may either correspond to a partial speech recognition result or an entire speech recognition result. Stated differently, the first and second pass speech recognition hypotheses 120a, 120b may either correspond a portion of an utterance 106 or an entire utterance 106. For example, the partial speech recognition result may correspond to a portion of a spoken utterance or even a portion of a spoken term. However, as will become apparent, the ASR model 200 performs additional processing on the second pass speech recognition hypothesis 120b whereby the second pass speech recognition hypothesis 120b may be delayed from the first pass speech recognition hypothesis 120a.

The user device 10 and/or the remote computing device 60 also executes a user interface generator 107 configured to present a representation of the transcription 120 of the utterance 106 to the user 104 of the user device 10. As described in greater detail below, the user interface generator 107 may display the first pass speech recognition hypothesis 120a in a streaming fashion during time 1 and subsequently display the second pass speech recognition hypothesis 120b in a streaming fashion during time 2. Notably, the ASR model 200 outputs the second pass speech recognition hypothesis 120b in a streaming fashion even though the second pass speech recognition hypothesis 120b improves upon the first pass speech recognition hypothesis 120a. In some configurations, the transcription 120 output from the ASR system 118 is processed, e.g., by a natural language understanding (NLU) module executing on the user device 10 or the remote computing device 60, to execute a user command/query specified by the utterance 106. Additionally or alternatively, a text-to-speech system (not shown) (e.g., executing on any combination of the user device 10 or the remote computing device 60) may convert the transcription 120 into synthesized speech for audible output by the user device 10 and/or another device.

In the example shown, the user 104 interacts with a program or application 50 (e.g., the digital assistant application 50) of the user device 10 that uses the ASR system 118. For instance, FIG. 1 depicts the user 104 communicating with the digital assistant application 50 and the digital assistant application 50 displaying a digital assistant interface 18 on a screen of the user device 10 to depict a conversation between the user 104 and the digital assistant application 50. In this example, the user 104 asks the digital assistant application 50, “What time is the concert tonight?” This question from the user 104 is a spoken utterance 106 captured by the audio capture device 16a and processed by audio systems 16 of the user device 10. In this example, the audio system 16 receives the spoken utterance 106 and converts it into a sequence of acoustic frames 110 for input to the ASR system 118.

Continuing with the example, the ASR model 200, while receiving the sequence of acoustic frames 110 corresponding to the utterance 106 as the user 104 speaks, encodes the sequence of acoustic frames 110 and then decodes the encoded sequence of acoustic frames 110 into the first pass speech recognition hypothesis 120a. During time 1, the user interface generator 107 presents, via the digital assistant interface 18, a representation of the first pass speech recognition hypothesis 120a of the utterance 106 to the user 104 of the user device 10 in a streaming fashion such that words, word pieces, and/or individual characters appear on the screen as soon as they are spoken. In some examples, the first look ahead audio context is equal to zero.

During time 2, the user interface generator 107 presents, via the digital assistant interface 18, a representation of the second pass speech recognition hypothesis 120b of the utterance 106 to the user 104 of the user device 10 a streaming fashion such that words, word pieces, and/or individual characters appear on the screen as soon as they are generated by the ASR model 200. In some implementations, the user interface generator 107 replaces the representation of the first pass speech recognition hypothesis 120a presented at time 1 with the representation of the second pass speech recognition hypothesis 120b presented at time 2. Here, time 1 and time 2 may include timestamps corresponding to when the user interface generator 107 presents the respective speech recognition result 120. In this example, the timestamp of time 1 indicates that the user interface generator 107 presents the first pass speech recognition hypothesis 120a at an earlier time than the second pass speech recognition hypothesis 120b. For instance, as the second pass speech recognition hypothesis 120b is presumed to be more accurate than the first pass speech recognition hypothesis 120a, the second pass speech recognition hypothesis 120b ultimately displayed as the transcription 120 may fix any terms that may have been misrecognized in the first pass speech recognition hypothesis 120a. In this example, the streaming first pass speech recognition hypothesis 120a output by the ASR model 200 are displayed on the screen of the user device 10 at time 1 are associated with low latency and provide responsiveness to the user 104 that his/her query is being processed, while the second pass speech recognition hypothesis 120b output by the ASR model 200 and displayed on the screen at time 2 leverages an additional speech recognition model and/or a language model to improve the speech recognition quality in terms of accuracy, but at increased latency. However, since the first pass speech recognition hypothesis 120a are displayed as the user speaks the utterance 106, the higher latency associated with producing, and ultimately displaying the second pass speech recognition hypothesis 120b is not noticeable to the user 104.

In the example shown in FIG. 1, the digital assistant application 50 may respond to the question posed by the user 104 using natural language processing. Natural language processing generally refers to a process of interpreting written language (e.g., the first pass speech recognition hypothesis 120a and/or the second pass speech recognition hypothesis 120b) and determining whether the written language prompts any action. In this example, the digital assistant application 50 uses natural language processing to recognize that the question from the user 104 regards the user's schedule and more particularly a concert on the user's schedule. By recognizing these details with natural language processing, the automated assistant returns a response 19 to the user's query where the response 19 states, “Venue doors open at 6:30 PM and concert starts at 8 pm.” In some configurations, natural language processing occurs on a remote server 60 in communication with the data processing hardware 12 of the user device 10.

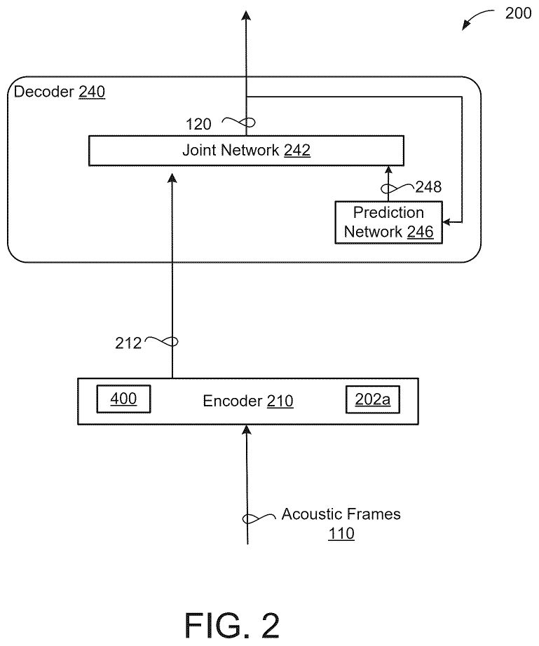

Referring now to FIG. 2, in some examples, the ASR model 200 includes an encoder 210 and a decoder 240. The ASR model 200 may operate in a streaming mode, a non-streaming mode, and some combination thereof and process utterances in multiple different languages. The encoder 10 may include a model structure where the encoding pathway includes two encoders that cascade such that the output of a first encoder (i.e., causal encoder) feeds the input of a second encoder (i.e., non-causal encoder) prior to decoding. The encoders 210 may include a stack of multi-headed (e.g., 8 heads) attention layers 202. In some examples, the stack of multi-headed attention layers of the encoders 21—includes a stack of 512-dimension of conformer layers. In other examples, transformer layers may be used in lieu of conformer layers. Moreover, the encoder 210 may include a plurality of adaptor modules 400 each inserted between (in parallel or sequentially) two consecutive multi-head attention layers 202 in the encoder 210.

The encoder 210 may include a causal encoder that includes 12 conformer layers each with a multi-headed (e.g., 8 heads) attention mechanism used as a self-attention layer. Moreover, each conformer layer of the encoder 210 may use causal convolution and left-context attention layers to restrict the first encoder from using any future inputs (e.g., right-context equal to zero).

With continued reference to FIG. 2, the encoder 210 receives a sequence of d-dimensional feature vectors (e.g., sequence of acoustic frames 110) x=(x₁, x₂, . . . x_{T}), where xₜ∈ [symbol] , and generates, at each output step of a plurality of output steps, a first higher order feature representation 212 for a corresponding acoustic frame 110 in the sequence of acoustic frames 110. The encoder 210 may generate the first higher order feature representation 212 based on the corresponding acoustic frame 110. The encoder 210 may operate in a streaming fashion such that, at each output step, the encoder 210 generates the first higher order feature representations 212 that correspond to either a portion of an utterance or an entire utterance.

In some examples, the decoder 240 includes a transducer decoder. The decoder 240 may include a recurrent neural network-transducer (RNN-T) architecture having a joint network 242 and a prediction network 246. In some examples, the decoder 240 includes a final softmax output layer (not shown). The decoder 240 uses the joint network 232 to combine the first higher order feature representation 212 output by the first encoder 210 and an average embedding 248 output from the prediction network 246 to generate a decoder output. That is, the joint network 242 is configured to receive, as input, the average embedding (i.e., dense representation) 248 output from the prediction network 246 and the first higher order feature representation 212 generated by the encoder 210 and generate, at each output step, a first probability distribution 120 over possible speech recognition hypotheses. Here, the first probability distribution 120b is based on the average embedding 248 and the first higher order feature representation 212.

Although not illustrated, the decoder 240 may include a final softmax layer that receives the output of the decoder 240. In some implementations, the softmax layer is separate from the decoder 240 and processes the output from the decoder 240. In other implementations, the softmax layer is integrated with the decoder 240 and processes the output from the joint network 242. The output of the softmax layer is then used in a beam search process to select orthographic elements.

In some implementations, the probability distribution 120 output by the decoder 240 include speech recognition result 120. As such, the speech recognition results 120 may be used interchangeable with the probability distributions 120 over possible speech recognition hypotheses. Thus, the joint network 242 may generate, at each output step (e.g., time step), a probability distribution 120 over possible speech recognition hypotheses. Here, the “possible speech recognition hypotheses” correspond to a set of output labels/symbols (also referred to as “speech units”) each representing a grapheme (symbol/character) or a word piece in a specified natural language. For example, when the natural language is English, the set of output labels may include twenty-seven (27) symbols, e.g., one label for each of the 26-letters in the English alphabet and one label designating a space. Accordingly, the joint network 242 may output a set of values indicative of the likelihood of occurrence of each of a predetermined set of output labels. The set of values can be a vector (e.g., a one-hot vector) and can indicate a probability distribution over the set of output labels. In some scenarios, the output labels are graphemes (e.g., individual characters, and potentially punctuation and other symbols), but the set of output labels is not so limited. For example, the set of output labels can include wordpieces and/or entire words, in addition to or instead of graphemes. The output labels could also be other types of speech units, such as phonemes or subphonemes. The probability distribution 120 output by the joint network 240 can include a posterior probability value for each of the different output labels. Thus, if there are 100 different output labels representing different graphemes or other symbols, the output of the joint network 240 can include 100 different probability values, one for each output label. The probability distribution 120 can then be used to select and assign scores to candidate orthographic elements (e.g., graphemes, wordpieces, and/or words) in a beam search process (e.g., by a final Softmax layer of the second joint network 250b (not shown)) for determining the speech recognition result 120. For example, the joint network 240 may select the N-best possible speech recognition hypotheses having the highest probabilities as output for the speech recognition result 120.

The decoder 240 may include a transducer decoder architecture. Within the decoder 240, the prediction network 246 may have two 2,048-dimensional LSTM layers, each of which is also followed by a 640-dimeinsinal projection layer. In some examples, the prediction network 246 includes a V2 embedding look-up table. The prediction network 246 receives, as input, a sequence of non-blank symbols output by the final Softmax layer of the joint network 242 and generates, at each output step, a dense representation (i.e., average embedding) 248. More specifically, the prediction network 246 generates a respective embedding for each non-blank symbol of the sequence of N previous non-blank symbols and generates the average embedding by averaging the respective embeddings. The joint network 242 receives the average embedding 248 for the previous acoustic frame 110 in the sequence of acoustic frames 110 and generates a subsequent probability distribution 120 using the average embedding 248.

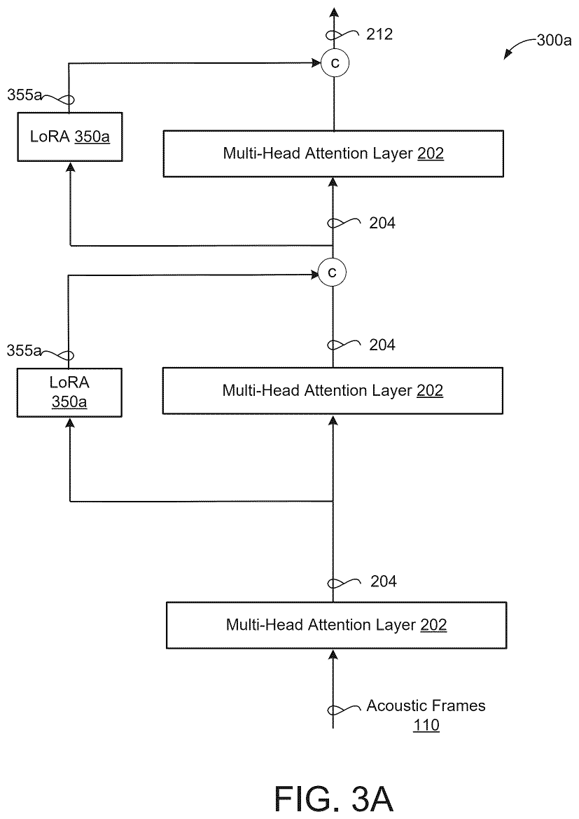

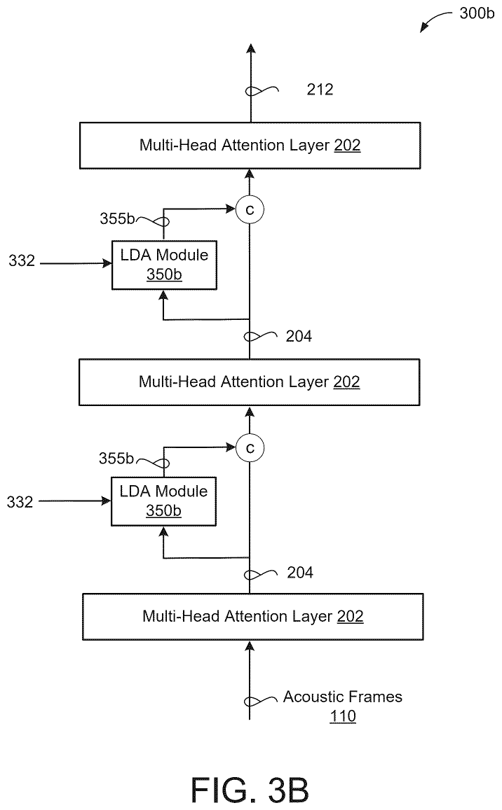

FIGS. 3A and 3B show schematic views 300a, 300b of an example stack of multi-head attention layers 202 corresponding to the encoder 210. In the example shown, the stack of multi-head attention layers 202 includes three (3) multi-head attention layers for the sake of clarify only, as it is understood that the stack of multi-head attention layers 202 may include any number of multi-head attention layers 202.

The schematic view 300a of FIG. 3A shows a plurality of adaptor modules 350, 350a inserted between the multi-head attention layers 202. In the example shown, each adaptor module 350a include a Low Rank Adapter (LoRA). However, the disclosure is not limited to any specific type of residual adapter, and may include residual adapters or other types of adaptor modules. Each corresponding adaptor module 350a of the plurality of adaptor modules 350a may be specific to a target speech domain. In some implementations, each adaptor module 350a specific to the target speech domain uses a weight matrix to project an encoder output 204 (also referred to as an “input representation”) to a lower-dimensional space with bottleneck dimension, followed by a nonlinear activation function, and then projects up to the original dimension using another weight matrix to provide an output 355a. In these implementation, a residual is also applied around the adaptor.

In the example shown, each adaptor module 402 is inserted in parallel between a corresponding pair of consecutive multi-head attention layers 202 of the encoder 210. In some examples, each multi-head attention layer 202 includes a respective feed forward network (FNN) end component such that each adaptor module includes an input connected to the respective FNN end of a first multi-head attention layer 202 in the corresponding pair of consecutive multi-head attention layers 202 and an output connected to the respective FNN end of a second multi-head attention layer in the corresponding pair of consecutive multi-head attention layers 202. Optionally, the adaptor module 402 may be inserted sequentially between consecutive multi-head attention layers 202 of the encoder 210.

The schematic view 300b of FIG. 3B shows each multi-head attention layer 202 is followed by a corresponding LDA module 350b from a plurality of LDA modules 350b. In other configurations, each multi-head attention layer 202 is followed by the corresponding LDA module 350b except for the final multi-head attention layer 202 stack of multi-head attention layers. Accordingly, each corresponding LDA module 350b is inserted between two consecutive multi-head attention layers 202 in the encoder 210. For instance, in the example shown, a first LDA module 350b is inserted between a first and second multi-head attention layer 202 and a second LDA module 350b is inserted between the second and third multi-head attention layer 202.

With continued reference to FIG. 3B, the initial multi-head attention layer 202 in the stack of multi-head attention layers 202 processes the sequence of acoustic frames to generate an encoder output 204, which may correspond to an input representation 204. Each corresponding multi-head attention layer 202 subsequent to an initial multi-head attention layer 202 is configured to receive a concatenation of the encoder output 204 from a previous multi-head attention layer 202 and output 355b of the corresponding LDA module 350b inserted between the corresponding multi-head attention layer 202 and the previous multi-head attention layer 202. Thus, each corresponding multi-head attention layer 202 subsequent to the initial multi-head attention layer 202 is configured to generate the encoder output 204 or the first higher order feature representation 212 based on the received concatenation. In the example shown, the first multi-head attention layer 202 generates the encoder output 204 by processing a corresponding acoustic frame 110 in the sequence of acoustic frames 110 which is fed to the first LDA module 350b that generates the output 355b that is concatenated with the encoder output 204 and fed to the subsequent (i.e., second) multi-head attention layer 202. Thereafter, the second multi-head attention layer 202 processes the concatenation to generate the encoder output 204 which is fed to the second LDA module 350b that generates the output 355b that is concatenated with the encoder output 204 and fed to the subsequent (i.e., third and final) multi-head attention layer 202. The Third multi-head attention layer 202 processes the concatenation to generate the first higher order feature representation 212. Moreover, the LDA modules 350b may receive a language ID vector 332 such that the LDA module generates the output 355b further based on the language ID vector 332 in addition to the encoder output 204. The language ID vector 332 may indicate a native language of spoken utterance characterized by the sequence of acoustic frames 110.

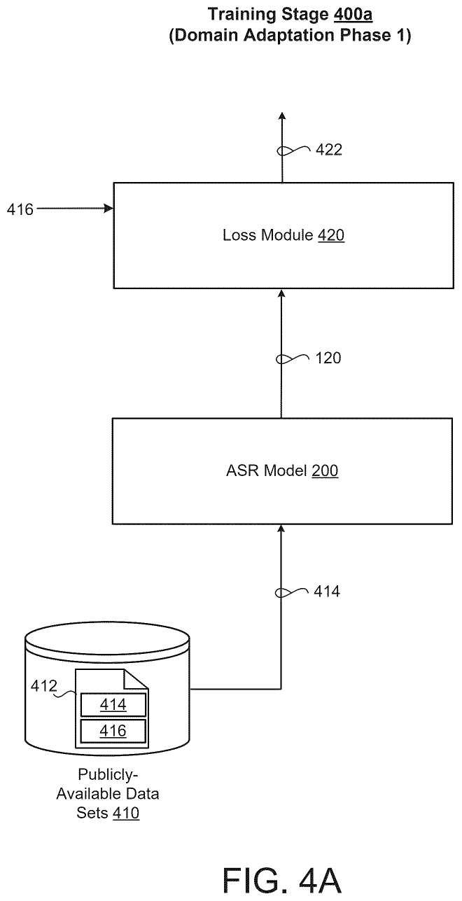

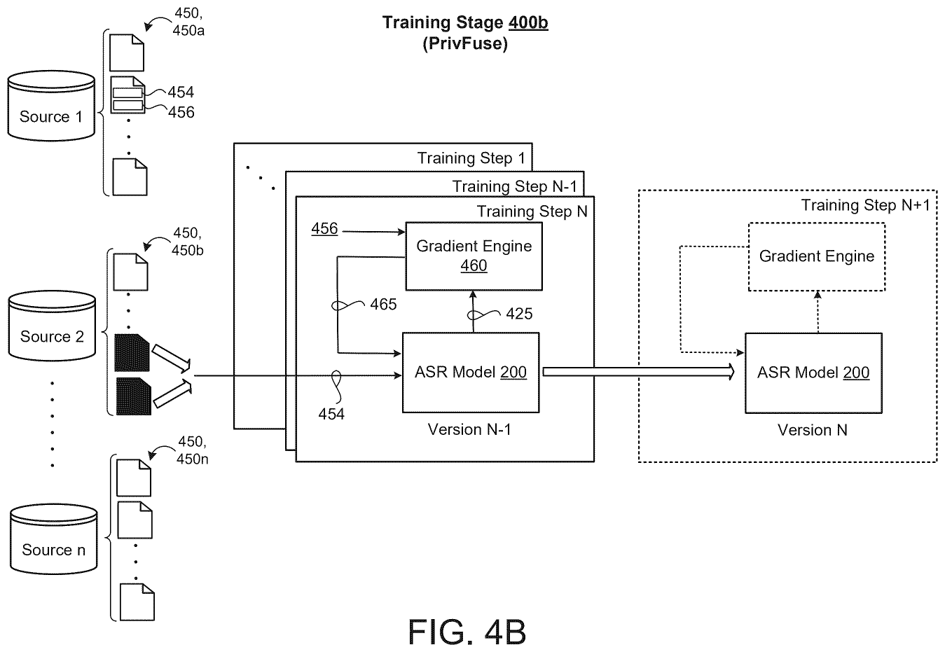

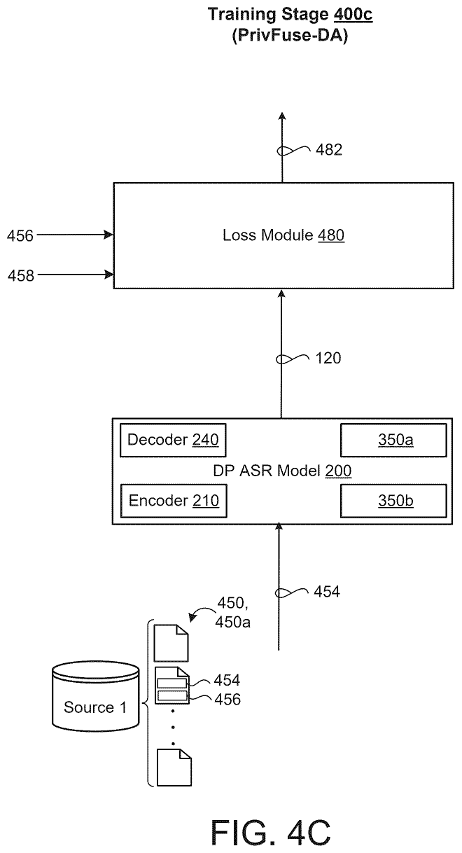

FIGS. 4A-4C illustrate an example three stage training process for adapting a base ASR model 200 to a target speech domain using private data from multiple different sources while preserving privacy between those sources. During the first or initial training stage 400a, the base ASR model 200 is pretrained on a plurality of public training utterances 412 obtained from publicly-available data sets 410 to provide a public-base ASR model 200. For instance, publicly-available data sets 410 may include public multilingual training utterances 412 spanning multiple different languages and dialects. One or more of the publicly-available data sets 410 may include training utterances 412 characterizing synthesized speech. Similarly, one or more of the publicly-available may include training utterances 412 characterizing non-synthetic or real speech recordings spoken by humans. The plurality of public training utterances 412 may include combinations of supervised public training utterances and unsupervised public training utterances. Supervised public training utterances each include audio data 414 characterizing an utterance and a corresponding ground-truth transcription 416, while unsupervised public training utterances only include unpaired audio data 414 characterizing corresponding utterances. Accordingly, the first training stage 400a may pre-train the ASR model 200 using any combination of supervised and unsupervised training techniques. For example, during supervised training, the base ASR model 200 may process the audio data 414 from a upservised public training utterance 412 to generate a probability distribution over possible speech recognition results 120 at each of a plurality of output steps. A loss module 420 may generate a loss 422 based on the probability stribution over possible speech recognition results 120 output by the ASR model 200 and the corresponding ground-truth transcription 416 of the utterance.

Unsupervised training may include pre-training only the encoder 210 of the ASR model 200 based on the unpaired audio data 414 from unsupervised public training utterances 412 such that the loss module 420 generates an unsupervised loss 420 based on predicted output from the encoder. The first training stage 400a may correspond to the first phase performed by conventional two-phase domain adaptation techniques.

Referring to FIG. 4B, once the public-base ASR model 200 is obtained via the pre-training on the plurality of public training utterances 312 during the first training stage 400a, a second training stage 400b updates the public-base ASR model 200 by leveraging private training utterances 450 obtained from a plurality of different sources while ensuring strong differentially private (DP)-based inter-source privacy between the multiple sources. In essence, the second training stage 400b corresponds to a DP-based collaborative training stage (PrivFuse) that updates the public-base ASR model 200 on multi-source private training utterances 250 while maintaining strong inter-source privacy to provide a DP-base ASR model 200 with improved performance for adaptation to different speech domains. Notably, while DP machine learning techniques conventionally amim to provide privacy to the training data used to train machine learning models, the DP-based collaborative training stage instead uses DP to leverage privacy sensitive multi-source data for improving domain adaptation of machine learning models (e.g., speech recognition models) to target domains. As such, since models adapted by conventional domain adaptation techniques suffer performance drops due to only leveraging the single-source private data associated with the target speech domain, the second training date 400b improves these conventional adaptation techniques for adapting base speech recognition models to target speech domains.

The second training stage 400b (PrivFuse) obtains a plurality of sets of private training utterances 450, 450a-n. Each corresponding set of private training utterances 450 is obtained from a corresponding different source and is associated with a corresponding speech domain that is different than the speech domains associated with the other sets of private training utterances 450. Each source may correspond to a respective one of the different speech domains. In some examples, the plurality of speech domains include a first speech domain associated with long queries greater than or equal to a first duration, a second domain associated with medium queries less than the first duration and greater than or equal to a second duration, and a third domain associated with short queries less than the second duration. Additionally or alternatively, some of the speech domains may correspond to different languages or dialects.

The second training stage 400b performs a plurality of training steps to update the public-base ASR model 200 as a DP-base ASR model 200 that may be adapted to a target speech domain during the third training stage 400c of FIG. 4C. With continued reference to FIG. 4B, at each respective training step N of the plurality of training steps subsequent to an initial training step 1, the second training stage trains or fine-tunes the public-base ASR model by obtaining a current version of the public-base ASR model 200 updated during the training step that immediately precedes the respective training step. Here, for the respective training step N, the current version of the public-base ASR model 200 that was updated during the training step N−1 is obtained. Next, at the respective training step N, the second training stage 400b selects a batch of private training utterances 450 from one of the plurality of sets of private training utterances 450, 450a-n, determines a DP gradient 465 for updating the current version of the public-base ASR model 200 based on the selected batch of private training utterances 450, and updates the current version of the public-base ASR model 200 using the differentially private gradient 465.

During each respective training step N, selecting the batch of private training utterances 450 may include randomly selecting the one of the plurality of sets of private training utterances 450 from the plurality of sets of private training utterances and selecting a subset of the private training utterances 450 from the randomly selected set of private training utterances 450. In the example shown, a second set of the private training utterances 450b may be randomly selected and the two shaded private training utterances are selected as the subset from the randomly selected second set of private training utterances 450. Each private training utterance may include audio data 454 characterizing the private training utterance 450 and a corresponding ground-truth transcription 456 of the corresponding private training utterance 450.

In some implementations, the respective training step N applies a gradient engine 460 to determine the differentially private gradient 465. Here, the current version of the public-base ASR model 200 processes the audio data 454 for each corresponding private training utterance in the batch of private training utterances to generate a predicted ASR result 425 and the gradient engine 460 generates the DP gradient 465 based on comparing the predicted ASR result 425 to the corresponding ground-truth transcription 456 of the corresponding private training utterance 450. In additional or alternative implementations, such as when the private ground truth(s) 144 corresponding to the private data 139 are unavailable, the gradient engine 142 generates the DP gradient(s) 143 using supervised and/or unsupervised learning techniques.

In some examples, determining the DP gradient 465 at each respective training step N includes: determining a per-utterance differentially private gradient for each private training utterance in the batch of private training utterances selected from the one of the plurality of sets of private training utterances 450; for each respective per-utterance DP gradient, clipping the respective per-utterance DP gradient to have a maximum loss; aggregating the clipped per-utterance DP gradients; and adding noise to the aggregated clipped per-utterance DP gradients. Adding noise may include setting a DP-SGD noise amplifier to achieve a target privacy budget. Notably, DP guarantees depend on the size of the training data such that as the size (i.e., duration) of the private training utterances reduces, privacy to the source associated with private training utterances increases. Accordingly, for examples where the plurality of different domains correspond to respective query lengths/durations, the DP-SGD noise ampliefer may be set to a value required to achieve a target privacy budget for the smallest data source, i.e., the short queries having durations less than the second duration. In some examples, the target privacy budge is set to a value less than or equal to 10 and the noise multipler is set to a value of 0.395.

After the respective training step N updates the current version of the public-base ASR model 200 to provide a new current version, the second training stage 400b advances to perform a next training step N+1 to update the new current version of the public-base ASR model 200 based on another batch of private training utterances 450 selected from one of the plurality of sets of private training utterances. The second training stage 400b may perform training steps until a target privacy budget exhausts, thereby resulting in a DP-base ASR model 200 that may be adapted to one or more target speech domains among the plurality of different speech domains. Notably, the DP-base model 200 is better aligned for adapting to a target speech domain than the public-base ASR model 200 pre-trained on the publicly-available data sets 410.

Referring to FIG. 4C, a third training stage 400c adapts the DP-base model 200 to learn how to recognize speech in a target speech domain from the plurality of speech domains using the corresponding set of private training utterances 450 associated with the target speech domain. In some implementations, with reference to FIGS. 3A and 4C, the DP-base model 200 is adapted using modular domain adaptation (MDA) by fine-tuning weights of the adaptor modules 350a specific to the target speech domain based on the corresponding set of private training utterances 450 associated with the target speech domain while parameters of the encoder 210 and the decoder 240 are held fixed. Here, for each corresponding private training utterance 450 associated with the target speech domain, the ASR model 200 processes the audio data 454 to determine a predicted speech recognition hypothesis (or probability distribution over possible speech recognition results) 120 and a loss module 480 computes a loss 482 based on the predicted speech recognition hypothesis 120 and the corresponding ground-truth transcription 456. The weights of the adaptor modules 350a specific to the target speech domain may be fine-tuned based on the losses 482 computed for the set of private training utterances 450 associated with the target speech domain. Additionally or alternatively, MDA may adapt the DP-base model 200 by fine-tuning a corresponding subset of parameters of the encoder 210 based on the corresponding set of private training utterances 450 associated with the target speech domain while the remaining parameters of the encoder and parameters of the decoder are held fixed. The corresponding subset of parameters of the encoder 210 may be fine-tuned based on the losses 482 computed for the set of private training utterances 450 associated with the target speech domain.

In some additional implementations, with reference to FIGS. 3A and 4C, the DP-base model 200 is adapted to recognize speech in a target speech domain that includes a target native language. In these examples, adapting the DP-base model to recognize speech in the target native language includes fine-tuning a corresponding set of language-dependent weights associated with each language dependent adapter module 350b specific to the target native language based on the corresponding set of private training utterances 450 associated with the target speech domain while parameters of the encoder 210 and the decoder 240 are held fixed. Moreover, each private training utterances 450 in the corresponding set of private training utterances 450 includes audio data 454 characterizing speech spoken in the target native language, a language identifier 458 identifying the target native language, and the corresponding transcription 456 of the utterance in a respective native script representing the target native language. Here, for each corresponding private training utterance 450 associated with the target native language, the ASR model 200 processes the audio data 454 to determine a predicted speech recognition hypothesis (or probability distribution over possible speech recognition results) 120 and the loss module 480 computes a loss 482 based on the predicted speech recognition hypothesis 120 and the corresponding ground-truth transcription 456. Moreover, the DP-base ASR model 200 may predict the language of each private training utterance 450 and activate the corresponding set of language-dependent weights of each LDA module 350b based on the prediction such that the ASR model generates the speech recognition result 120 with only the activated corresponding set of language-dependent weights. The loss module 480 may further determine the loss 482 based on the language identifier 458 identifying the respective native language of the private training utterance.

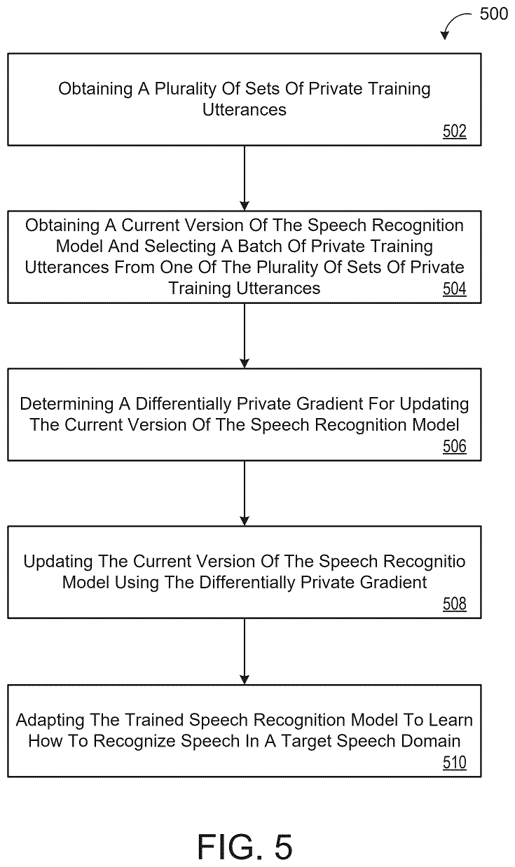

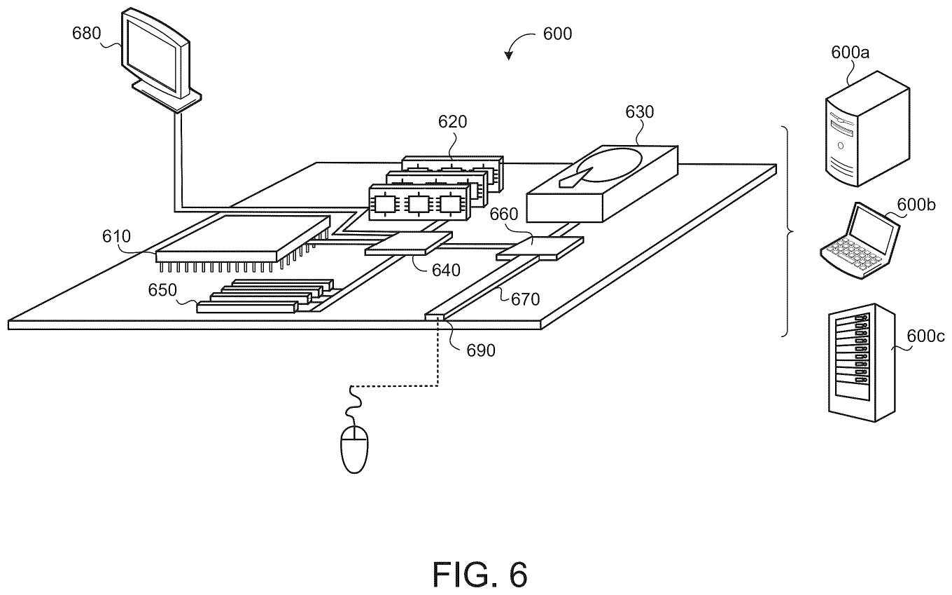

FIG. 5 is a flowchart of an example arrangement of operations for a computer-implemented method 500 for adapting a base ASR model 200 to a target speech domain using private data from multiple different sources while preserving privacy between those sources. The method 500 may execute on data processing hardware 610 (FIG. 6) using instructions stored on memory hardware 620 (FIG. 6). The data processing hardware 610 and the memory hardware 620 may reside on the user device 10 and/or the remote computing device 60 each corresponding to a computing device 600 (FIG. 6).

At operation 502, the method 500 includes obtaining a plurality of sets of private training utterances 450. Each corresponding set of private training utterances 450 is obtained from a corresponding different source and is associated with a corresponding speech domain that is different than the speech domains associated with the other sets of private training utterances. Operations 504-508 are performed at each respective training step of a plurality of training steps subsequent to an initial training step to train the ASR model 200. The ASR model 200 being trained during operations 504-508 may include the public-base ASR model 200 pretrained on the publicly-available data sets 410 during the first training stage 400a of FIG. 4A.

At operation 504, the method includes obtaining a current version of the ASR model 200 updated during the training step that immediately precedes the respective training step and selecting a batch of private training utterances from one of the plurality of sets of private training utterances 450. At operation 506, the method includes determining a differentially private gradient 465 for updating the current version of the ASR model 200 based on the selected batch of private training utterances 450. At operation 510, the method includes updating the current version of the ASR model 200 using the differentially private gradient 465.

At operation 506, the method 500 includes adapting the trained ASR model 200 to learn how to recognize speech in a target speech domain from the plurality of speech domains using the corresponding set of private training utterances associated with the target speech domain. For instance, the trained ASR model may include the DP-base ASR model that is adapted during the third training stage 400c of FIG. 4C.

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
obtaining a plurality of sets of private training utterances, each corresponding set of private training utterances obtained from a corresponding different source and associated with a corresponding speech domain that is different than the speech domains associated with the other sets of private training utterances,
at each respective training step of a plurality of training steps subsequent to an initial training step, training a speech recognition model by:
obtaining a current version of the speech recognition model updated during the training step that immediately precedes the respective training step;
selecting a batch of private training utterances from one of the plurality of sets of private training utterances;
determining a differentially private gradient for updating the current version of the speech recognition model based on the selected batch of private training utterances; and
updating the current version of the speech recognition model using the differentially private gradient; and
adapting the trained speech recognition model to learn how to recognize speech in a target speech domain from the plurality of speech domains using the corresponding set of private training utterances associated with the target speech domain.

2. The computer-implemented method of claim 1, wherein the speech recognition model is initially pretrained on public training data associated with multiple speech domains.

3. The computer-implemented method of claim 1, wherein selecting the batch of private training utterances from the one of the plurality of sets of private training utterances comprises:
randomly selecting the one of the plurality of sets of private training utterances from the plurality of sets of private training utterances; and
selecting a subset of the private training utterances from the randomly selected set of private training utterances.

4. The computer-implemented method of claim 1, wherein determining the differentially private gradient for updating the current version of the speech recognition model based on the selected batch of private training utterances comprises:
determining a per-utterance differentially private gradient for each private training utterance in the batch of private training utterances selected from the one of the plurality of sets of private training utterances;
for each respective per-utterance differentially private gradient, clipping the respective per-utterance differentially private gradient to have a maximum loss;
aggregating the clipped per-utterance differentially private gradients; and
adding noise to the aggregated clipped per-utterance differentially private gradients.

5. The computer-implemented method of claim 1, wherein the speech recognition model comprises:
an encoder comprising a plurality of multi-head attention layers; and
a decoder having a recurrent neural network-transducer (RNN-T) architecture.

6. The computer-implemented method of claim 5, wherein adapting the trained speech recognition model comprises adapting the trained speech recognition model using modular domain adaptation by at least one of:
fine-tuning a corresponding subset of parameters of the encoder based on the corresponding set of private training utterances associated with the target speech domain while the remaining parameters of the encoder and parameters of the decoder are held fixed; or
fine-tuning weights of adaptor modules specific to the target speech domain based on the corresponding set of private training utterances associated with the target speech domain while the parameters of the encoder and the decoder are held fixed.

7. The computer-implemented method of claim 6, wherein each corresponding adaptor module of the adaptor modules specific to the target speech domain is inserted in parallel between a corresponding pair of consecutive multi-head attention layers of the encoder.

8. The computer-implemented method of claim 5, wherein:
the target speech domain comprises speech in a target native language; and
adapting the trained speech recognition model comprises adapting the trained speech recognition model using language-dependent adapter modules by fine-tuning a corresponding set of language-dependent weights associated with each language dependent adapter module that are specific to the target native language based on the corresponding set of private training utterances associated with the target speech domain while parameters of the encoder and the decoder are held fixed.

9. The computer-implemented method of claim 8, wherein each corresponding language-dependent adapter module is inserted between a corresponding pair of consecutive multi-head attention layers of the encoder.

10. The computer-implemented method of claim 1, wherein the plurality of speech domains comprises a first speech domain associated with long queries greater than or equal to a first duration, a second domain associated with medium queries less than the first duration and greater than or equal to a second duration, and a third domain associated with short queries less than the second duration.

11. A system comprising:
data processing hardware; and
memory hardware in communication with the data processing hardware and storing instructions that when executed on the data processing hardware causes the data processing hardware to perform operations comprising:
obtaining a plurality of sets of private training utterances, each corresponding set of private training utterances obtained from a corresponding different source and associated with a corresponding speech domain that is different than the speech domains associated with the other sets of private training utterances;
at each respective training step of a plurality of training steps subsequent to an initial training step, training a speech recognition model by:
obtaining a current version of the speech recognition model updated during the training step that immediately precedes the respective training step;
selecting a batch of private training utterances from one of the plurality of sets of private training utterances;
determining a differentially private gradient for updating the current version of the speech recognition model based on the selected batch of private training utterances; and
updating the current version of the speech recognition model using the differentially private gradient; and
adapting the trained speech recognition model to learn how to recognize speech in a target speech domain from the plurality of speech domains using the corresponding set of private training utterances associated with the target speech domain.

12. The system of claim 11, wherein the speech recognition model is initially pretrained on public training data associated with multiple speech domains.

13. The system of claim 11, wherein selecting the batch of private training utterances from the one of the plurality of sets of private training utterances comprises:
randomly selecting the one of the plurality of sets of private training utterances from the plurality of sets of private training utterances; and
selecting a subset of the private training utterances from the randomly selected set of private training utterances.

14. The system of claim 11, wherein determining the differentially private gradient for updating the current version of the speech recognition model based on the selected batch of private training utterances comprises:
determining a per-utterance differentially private gradient for each private training utterance in the batch of private training utterances selected from the one of the plurality of sets of private training utterances;
for each respective per-utterance differentially private gradient, clipping the respective per-utterance differentially private gradient to have a maximum loss;
aggregating the clipped per-utterance differentially private gradients; and
adding noise to the aggregated clipped per-utterance differentially private gradients.

15. The system of claim 11, wherein the speech recognition model comprises:
an encoder comprising a plurality of multi-head attention layers; and
a decoder having a recurrent neural network-transducer (RNN-T) architecture.

16. The system of claim 15, wherein adapting the trained speech recognition model comprises adapting the trained speech recognition model using modular domain adaptation by at least one of:
fine-tuning a corresponding subset of parameters of the encoder based on the corresponding set of private training utterances associated with the target speech domain while the remaining parameters of the encoder and parameters of the decoder are held fixed; or
fine-tuning weights of adaptor modules specific to the target speech domain based on the corresponding set of private training utterances associated with the target speech domain while the parameters of the encoder and the decoder are held fixed.

17. The system of claim 16, wherein each corresponding adaptor module of the adaptor modules specific to the target speech domain is inserted in parallel between a corresponding pair of consecutive multi-head attention layers of the encoder.

18. The system of claim 15, wherein:
the target speech domain comprises speech in a target native language; and
adapting the trained speech recognition model comprises adapting the trained speech recognition model using language-dependent adapter modules by fine-tuning a corresponding set of language-dependent weights associated with each language dependent adapter module that are specific to the target native language based on the corresponding set of private training utterances associated with the target speech domain while parameters of the encoder and the decoder are held fixed.

19. The system of claim 18, wherein each corresponding language-dependent adapter module is inserted between a corresponding pair of consecutive multi-head attention layers of the encoder.

20. The system of claim 11, wherein the plurality of speech domains comprises a first speech domain associated with long queries greater than or equal to a first duration, a second domain associated with medium queries less than the first duration and greater than or equal to a second duration, and a third domain associated with short queries less than the second duration.
